(19) United States
(12) Patent Application Publication
(10) Pub. No.: US 2022/0240458 A1
(43) Pub. Date: Aug. 4, 2022

(54) AIR DISTRIBUTION AND HEAT EXTRACTION FOR PLANT CANOPY

(71) Applicant: AGRICULTRA ADVANCEMENTS INC., Burlington, CA (US)

(72) Inventors: Emil V. Breza, Beamsville (CA); Ian Matheson, Toronto (CA)

(21) Appl. No.: 17/610,107

(22) PCT Filed: May 8, 2020
(86) PCT No.: PCT/CA2020/050630

§ 371 Date: Nov. 9, 2021

Related U.S. Application Data
(60) Provisional application No. 62/846,362, filed on May 10, 2019.
(60) Provisional application No. 62/933,031, filed on Nov. 8, 2019.

(51) Int. Cl. A01G 7/04; F24F 3/056; F24F 7/10

(52) U.S. Cl. CPC A01G 7/045; F24F 2221/02; F24F 7/10; F24F 3/056

(57) ABSTRACT

Positive air pressure is applied on a ventral side of a plant canopy and negative air pressure is applied on a dorsal side of the plant canopy. By this arrangement, the negative air pressure draws air supplied by the positive air pressure on the ventral side of the plant canopy across the plant canopy past the dorsal side of the plant canopy to withdraw heat from the plant canopy, for example, from an agricultural lighting system and/or humidity from plant respiration in a controlled indoor environment.

### CROSS-REFERENCE TO RELATED APPLICATIONS

This application claims priority to U.S. Provisional Application No. 62/846,362 filed on May 10, 2019 and to U.S. Provisional Application No. 62/933,031 filed on Nov. 8, 2019, the teachings of each of which are hereby incorporated by reference.

### BACKGROUND

Indoor horticultural applications often require the use of artificial light as a substitute for, or a supplement to, natural lighting in order to promote the growth of the plants being cultivated. Artificial lighting used to promote the growth of plants is referred to herein as “agricultural lighting”, and the systems used to provide such light are referred to as “agricultural lighting systems”. Such artificial light may include the ultraviolet (UV) portion of the spectrum.

Agricultural lighting systems can generate considerable heat, which can be damaging, and potentially fatal, to the plants being cultivated. In addition to the heat generated by the agricultural lighting system there is also heat and humidity produced from plant respiration, which, in a controlled indoor environment, can be greater than the heat from the agricultural lighting system. Attempts to manage this heat have often focused on first controlling the temperature and air flow in the facility in which the plants are being grown, and then on controlling the temperature and air flow in the particular room(s) in which the plants are being grown. This approach can be wasteful and energy inefficient by circulating and cooling more air than may be necessary, and may yet fail to effectively remove heat from the plants.

### BRIEF SUMMARY

In one aspect, a method for air distribution and heat extraction for a plant canopy comprises applying positive air pressure on a ventral side of the plant canopy while applying negative air pressure on a dorsal side of the plant canopy so that the negative air pressure draws air supplied by the positive air pressure on the ventral side of the plant canopy across the plant canopy past the dorsal side of the plant canopy to withdraw heat from the plant canopy. The heat may be, for example, from an agricultural lighting system.

In another aspect, an air distribution and heat extraction system for plant cultivation comprises a support, at least one plant carried by the support, the at least one plant having a plurality of leaves forming at least one plant canopy, at least one air supply duct positioned and configured to apply positive air pressure on a ventral side of the at least one plant canopy, and at least one air return duct positioned and configured to apply negative air pressure on a dorsal side of the at least one plant canopy. When the positive air pressure and the negative air pressure are applied, the negative air pressure draws air supplied by the positive air pressure on the ventral side of the at least one plant canopy across the at least one plant canopy past the dorsal side of the at least one plant canopy to withdraw heat from the at least one plant canopy.

### BRIEF DESCRIPTION OF THE SEVERAL VIEWS OF THE DRAWINGS

These and other features will be described with reference to the following illustrative drawings, wherein.

FIG. 1 illustrates, in schematic form, a method for air distribution and heat extraction for a plant canopy.

FIG. 2 illustrates an air distribution and heat extraction system in accordance with a first embodiment.

FIG. 3 shows an illustrative air distribution and heat extraction system similar to that shown in FIG. 2 but in which the support is a tiered support comprising a plurality of individual tiers.

FIG. 4 shows two illustrative air return ducts coupled to an illustrative agricultural lighting system.

FIG. 5 shows an illustrative air return duct arranged in opposed relation to, and in registration with, a corresponding air supply duct.

FIG. 6 shows how two sets of ducts can be connected to form a complete air return duct.

FIG. 7 is a top perspective view of a multipurpose cultivation carrier that can be used in accordance with aspects of the present disclosure.

FIGS. 8A and 8B show how plant containers can be slidingly received in the multipurpose cultivation carrier of FIG. 7.

FIGS. 9A and 9B show how manifold plates can be slidingly received in the multipurpose cultivation carrier to form an air manifold.

FIGS. 10A, 10B and 11 are partial cut-away views illustrating an air distribution and heat extraction system in accordance with a second embodiment.

FIG. 12 is a partially exploded, partial cut-away top front perspective view illustrating an air distribution and heat extraction system in accordance with a third embodiment.

FIG. 12A is a detail view of a portion of FIG. 12.

FIG. 13 is an assembled partial cut-away top front perspective view of the air distribution and heat extraction system of FIG. 12.

FIG. 14 is an assembled front perspective view of the air distribution and heat extraction system of FIG. 12 with a light containment curtain thereof partially open.

FIG. 15 is an assembled front perspective view of the air distribution and heat extraction system of FIG. 12 with the light containment curtain thereof closed.

FIG. 16 is a partially exploded, partial cut-away top rear perspective view of the air distribution and heat extraction system of FIG. 12.

FIG. 17 is an assembled partial cut-away top rear perspective view of the air distribution and heat extraction system of FIG. 12.

### DETAILED DESCRIPTION

The present disclosure describes a “plant forward” solution which focuses primarily on removing undesired heat and humidity from the plants, and particularly from the vulnerable plant canopy. Air is made to flow directly across the plant canopy from a ventral side thereof to a dorsal side thereof.

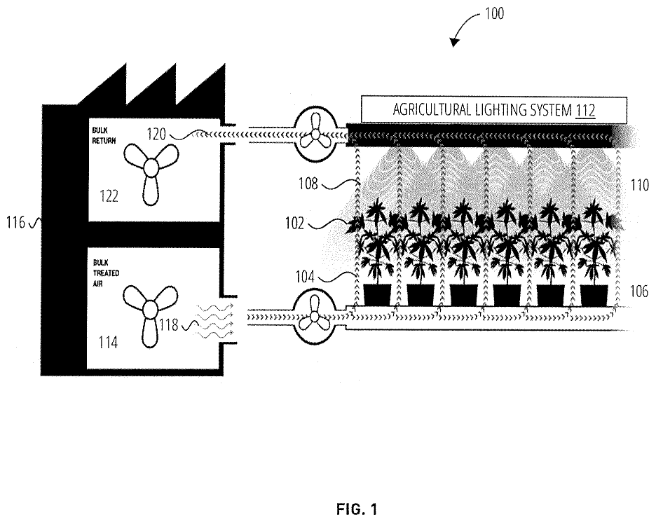

Reference is now made to FIG. 1, which illustrates, in schematic form, a method 100 for air distribution and heat extraction for a plant canopy, denoted generally by reference 102. The method comprises applying positive air pressure 104 on a ventral side 106 of the plant canopy 102 and applying negative air pressure 108 on a dorsal side 110 of the plant canopy 102. By this arrangement, the negative air pressure 108 draws air supplied by the positive air pressure 104 on the ventral side 106 of the plant canopy 102 across the plant canopy 102 past the dorsal side 110 of the plant canopy 102 to withdraw heat from the plant canopy 102. The heat may be, for example, primarily from an agricultural lighting system 112. For example, the MetaRail™ or HyperRail™ agricultural lighting system offered by AgricUltra Advancements Inc., having an address at 905-5500 North Service Road, Burlington, ON L7L 6W6, Canada, may be used. The MetaRail agricultural lighting system provides UVA and UVB light, and the HyperRail agricultural lighting system provides UVA, UVB and visible light.

In the illustrated embodiment, the positive air pressure 104 results from forced air 118, for example from a bulk treated air source 114 of an HVAC system 116 (“HVAC” refers to “heating, ventilation and air conditioning”), and the negative air pressure 108 results from suction 120 into a bulk return inlet 122 of the HVAC system 116. Preferably, the forced air 118 is actively cooled, for example by the HVAC system 116 before reaching the ventral side 106 of the plant canopy 102. Also preferably, the forced air is cleaned, for example by way of filter and/or electrostatic treatment and/or UV treatment, before reaching the ventral side 106 of the plant canopy 102. In other embodiments, where the ambient temperature is low enough, the forced air may be ambient air.

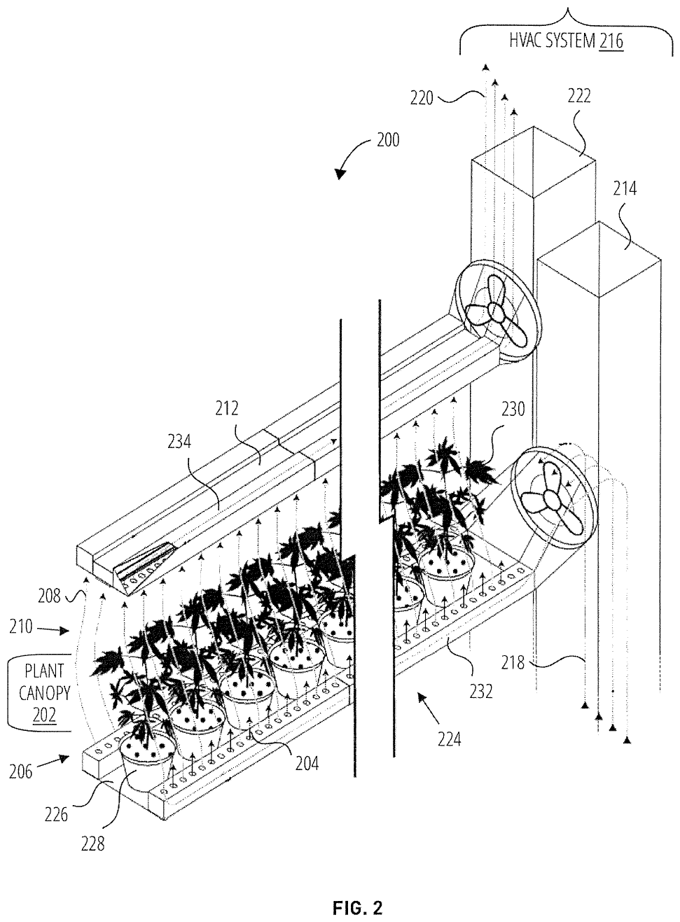

Reference is now made to FIG. 2, in which an illustrative air distribution and heat extraction system 200 for plant cultivation is shown. This is merely one illustrative embodiment, and is not intended to be limiting.

The air distribution and heat extraction system 200 comprises a support 224 which includes a longitudinally extending platform 226, and further comprises a longitudinally extending agricultural lighting system 212, two air supply ducts 232, two air return ducts 234, and a plurality of plants 228 carried by the platform 226. Each of the plants 228 has a plurality of leaves 230 forming a plant canopy 202. While the illustrated embodiment shows a plurality of plants 228 carried by the platform 226, in other embodiments there may be only a single plant carried by the support, with the leaves of the single plant forming the plant canopy. The agricultural lighting system 212 is disposed on the dorsal side of the plant canopy 202 and is arranged substantially parallel to and in registration with the platform 226 so as to deliver agricultural light to the dorsal side 210 of the plant canopy 202.

In the illustrated embodiment, the air supply ducts 232 are disposed on either side of the platform 226 along the long edges thereof, and the air return ducts 234 are similarly disposed on either side of the agricultural lighting system 212 along the long edges thereof. Thus, in the illustrated embodiment the air return ducts 234 are carried by the agricultural lighting system 212. In other embodiments, the air return duct(s) may be separate from and unsupported by the agricultural lighting system. While the illustrated embodiment has two air supply ducts 232 and two air return ducts 234, other embodiments may have a single air supply duct and/or more than two air supply ducts and/or only a single air return duct and/or more than two air return ducts.

The air supply ducts 232 are positioned and configured to apply positive air pressure 204 on the ventral side 206 of the plant canopy 202 and the air return ducts 234 are positioned and configured to apply negative air pressure 208 on the dorsal side of the plant canopy 202. By this arrangement, when the positive air pressure 204 and the negative air pressure 208 are applied, the negative air pressure 208 draws air supplied by the positive air pressure 204 on the ventral side 206 of the plant canopy 202 across the plant canopy 202 past the dorsal side 210 of the plant canopy 202 to withdraw heat from the plant canopy 202. There may also be considerable humidity around the plant canopy 202, substantially from plant respiration; as the negative air pressure 208 draws air supplied by the positive air pressure 204 on the ventral side 206 of the plant canopy 202 across the plant canopy 202 past the dorsal side 210 of the plant canopy 202 it will also withdraw humidity from the plant canopy 202

As can be seen in FIG. 2, the air supply ducts 232 are coupled in fluid communication with an HVAC system 216 and configured to receive treated forced air 218 from the HVAC system 216; the forced air 218 from the HVAC system 216 may be actively cooled and/or cleaned. Similarly, the air return ducts 234 are coupled in fluid communication with the HVAC system 216 and configured to deliver the air drawn from the plant canopy 202 to a bulk return inlet 222 of the HVAC system 216. In other embodiments, the air return ducts 234 may vent to ambient.

In the illustrated embodiment, the platform 226 is shown spaced from the floor of a building in which the air distribution and heat extraction system 200 is disposed; in other embodiments the building floor may itself serve as the support, and the air supply duct(s) may be embedded in the building floor.

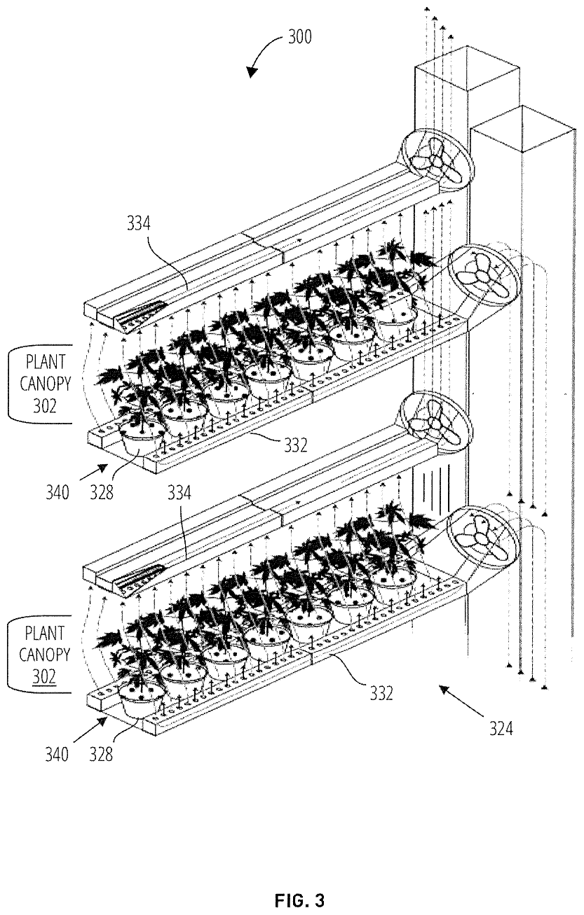

FIG. 3 shows an illustrative air distribution and heat extraction system 300 which is similar to the air distribution and heat extraction system 200 shown in FIG. 2 but in which the support 324 is a tiered support 324 comprising a plurality of individual tiers 340. A plurality of plants 328 are arranged on the tiers 340 of the tiered support 324 whereby there are a plurality of tiered plant canopies 302, and there are a plurality of air return ducts 334 disposed on the dorsal sides of respective ones of the plant canopies 302. In the illustrated embodiment shown in FIG. 3, a plurality of air supply ducts 332 are disposed on ventral sides of respective ones of the plant canopies 302; in other embodiments a single air supply duct may be disposed on the ventral side of the lowermost plant canopy.

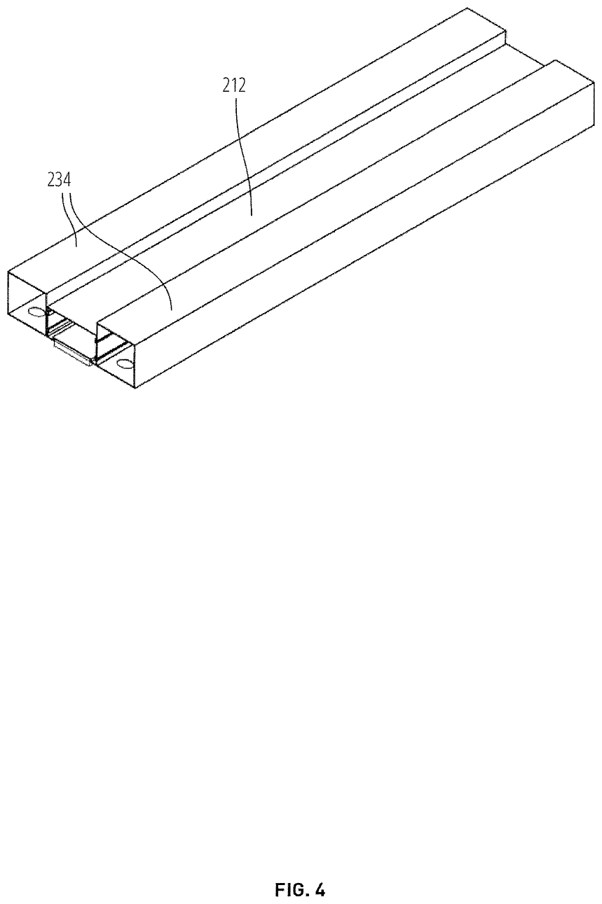

FIG. 4 shows two illustrative air return ducts 234 coupled to an illustrative agricultural lighting system 212. Although FIG. 4 shows the air return ducts 234 on both sides of the agricultural lighting system 212, on other embodiments there may be only a single air return duct on one side of the agricultural lighting system 212. Similar arrangements may be used with respect to the air supply ducts 232 and the platform 226. In the illustrated embodiment, coupling is by way of a channel-and-groove interference fit although any suitable coupling mechanism may be used.

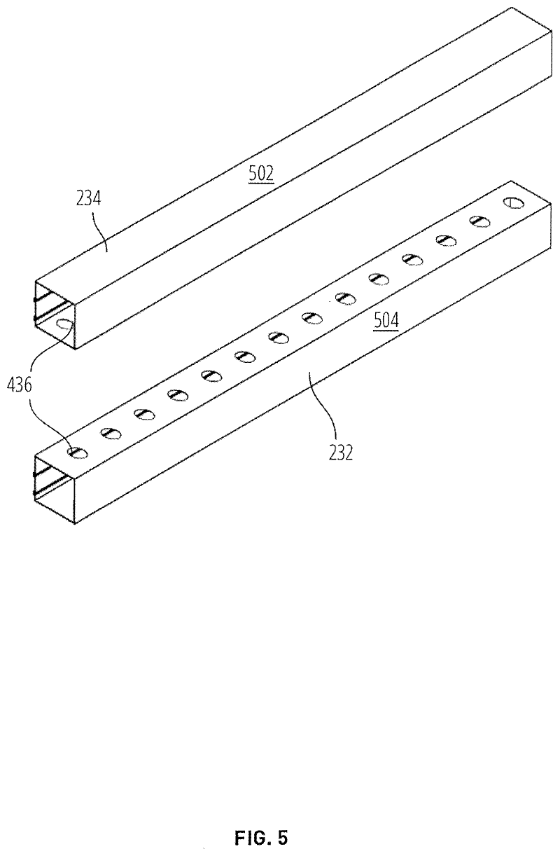

FIG. 5 shows an illustrative air return duct 234 arranged in opposed relation to, and in registration with, a corresponding air supply duct 232. In the illustrated embodiment, the air return ducts 234 and air supply ducts 232 take the form of open-ended, hollow rectangular duct 502, 504 having a series of airflow apertures 436. The ducts 502, 504 may be of various sizes to accommodate various airflow requirements and/or HVAC systems. For example, ducts 502, 504 may be provided which are sized to remove 700 cubic feet per minute (CFM), 1000 CFM or 1200 CFM, depending on the application.

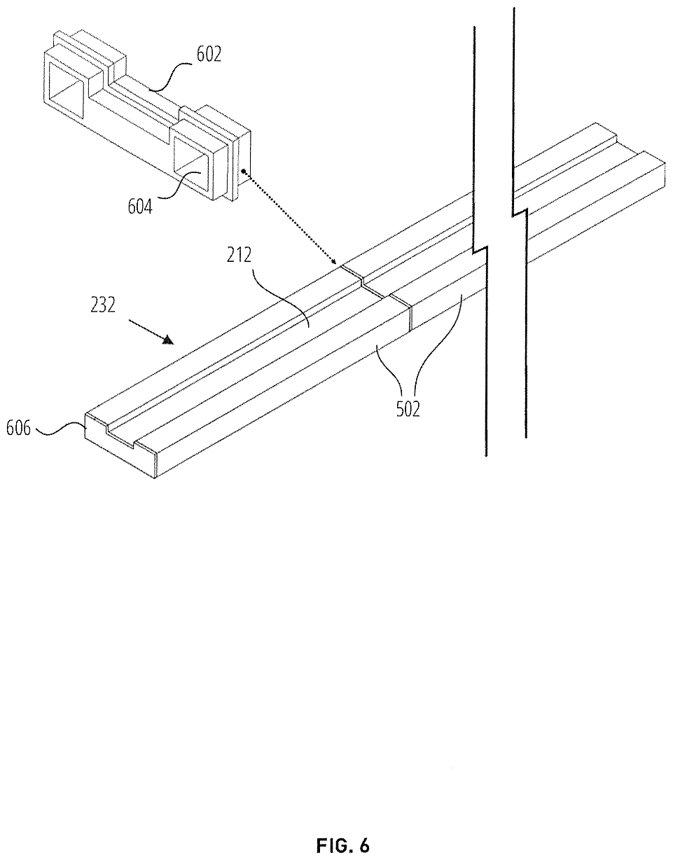

FIG. 6 shows how two sets of ducts 502 can be connected end-to-end in fluid communication using an O-ring style sealable connector 602 having at least one airflow passage 604 therethrough and a sealing endcap 606 at a downstream terminal end, so as to form a complete air supply duct 232. A similar approach can be used to connect ducts 504 to form a complete air return duct 234.

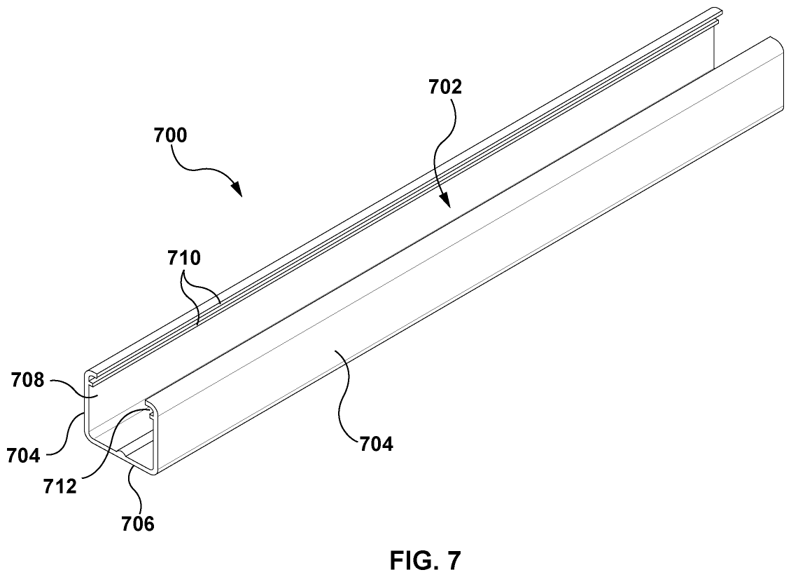

Reference is now made to FIGS. 7 to 9B, which show a multipurpose cultivation carrier, indicated generally by reference 700, which can be used in accordance with aspects of the present disclosure. The multipurpose cultivation carrier 700 may be configured for use as a plant carrier, or as an air plenum for an air manifold.

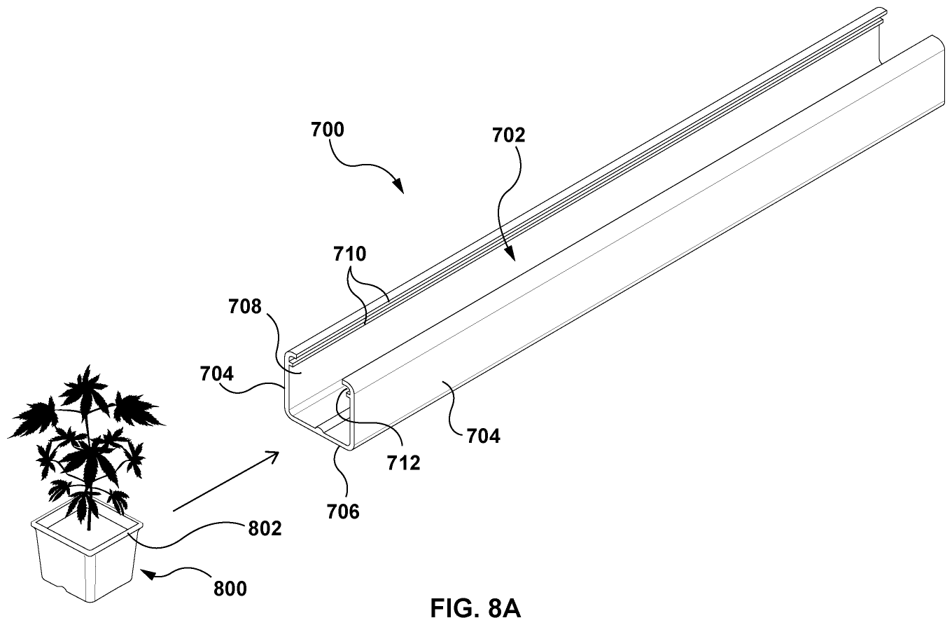

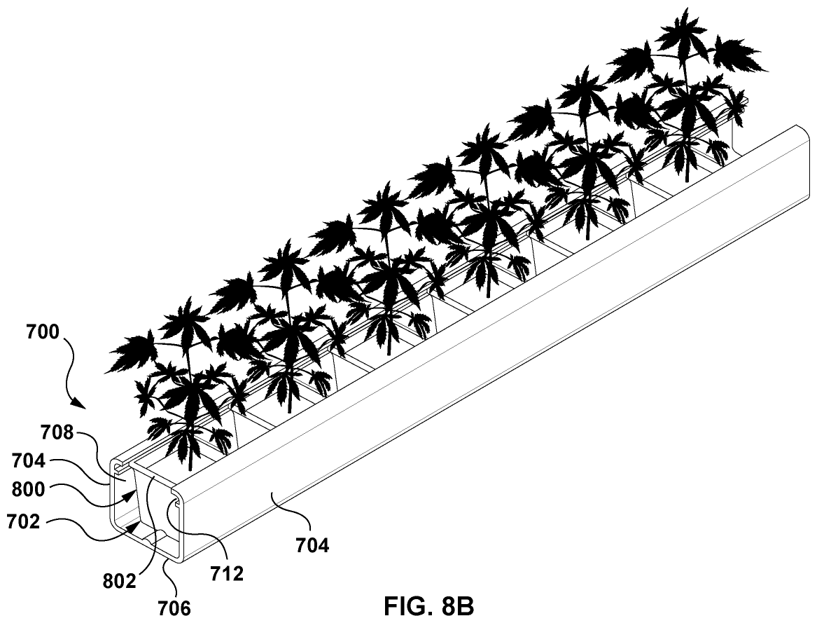

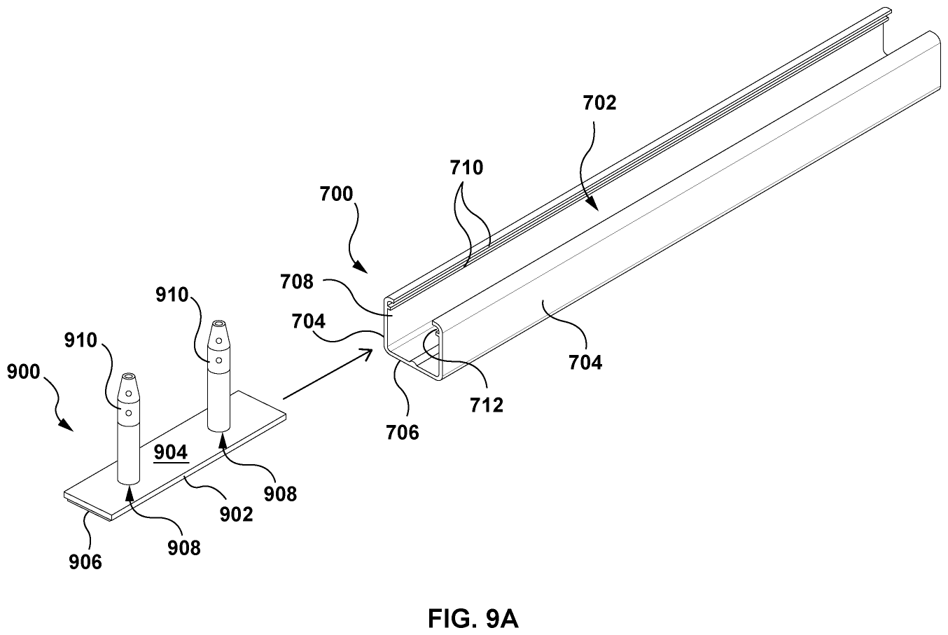

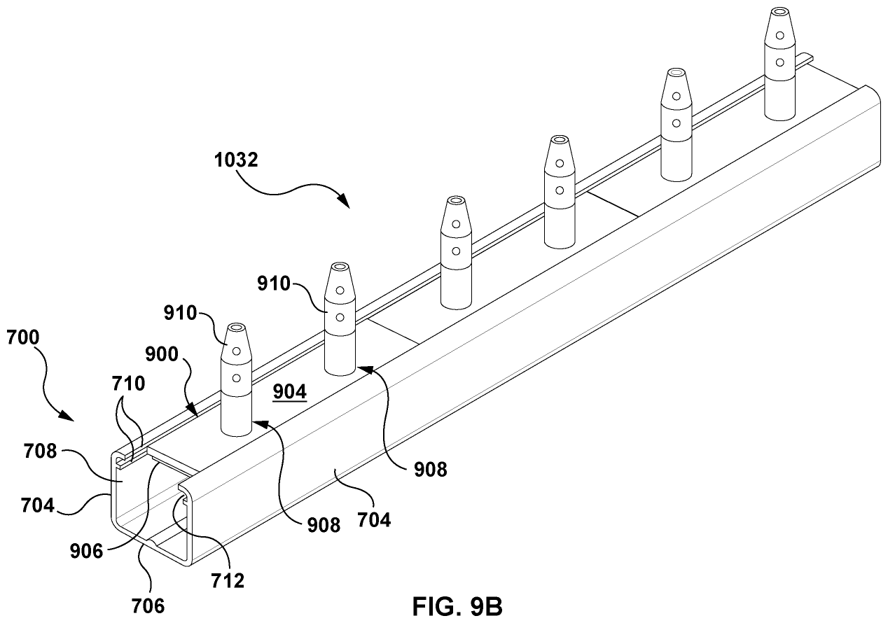

The multipurpose cultivation carrier 700 has a longitudinally extending channel 702 defined therein and is adapted to removably slidably receive instances of a plant container 800 (FIG. 8A) or a manifold plate 900 (FIG. 9A). The multipurpose cultivation carrier 700 is of generally C-shaped cross section. The illustrated multipurpose cultivation carrier 700 comprises two opposed, substantially parallel generally planar sidewalls 704 spaced from one another by a generally planar base wall 706. The inner faces 708 of the sidewalls 704 have opposed longitudinally-extending inward projections 710 which form longitudinally extending guide grooves 712 that are dimensioned to receive the peripheral rim 802 (FIG. 8A) of the plant container 800 so as to maintain the plant container 800 within the longitudinally extending channel 702. Thus, the plant container 800 can be slid into the longitudinally extending channel 702 as shown in FIG. 8A. Typically, a series of the plant containers 800 are received in the channel 702, as shown in FIG. 8B.

The longitudinally extending guide grooves 712 are further dimensioned to receive the outer side edges 902 of a manifold plate 900. Such a manifold plate 900 is shown in FIG. 9A and, in the illustrated embodiment, comprises a main plate 904 that includes a guide projection 906 on its underside to help center it in the longitudinally extending channel 702. Other arrangements for securing a manifold plate to the multipurpose cultivation carrier 700 may also be used. The ends of each manifold plate 900 may comprise a tongue and groove snap (not shown) with the male end sliding over the female end forming a partial seal and locking the manifold plates 900 together end-to-end. The manifold plate 900 further comprises two upwardly depending nipples 908 each adapted to releasably sealingly receive a diffuser/reducer 910. The air flow can be adjusted by selectively installing a diffuser/reducer 910 having the desired flow rate. A series of the manifold plates 900 can be slid into the channel 702 in sealed end-to-end relation as shown in FIG. 9A, and then a sealing member (not shown) can be installed at one end of the multipurpose cultivation carrier 700 so that the multipurpose cultivation carrier 700 serves as an air plenum and cooperates with the manifold plates 900, nipples 908 and diffuser/reducers 910 to form an air manifold 1032, as shown in FIG. 9B. The multipurpose cultivation carrier 700 may be used, for example, in a modular recirculating embodiment of an air distribution and heat extraction system according to an aspect of the present disclosure.

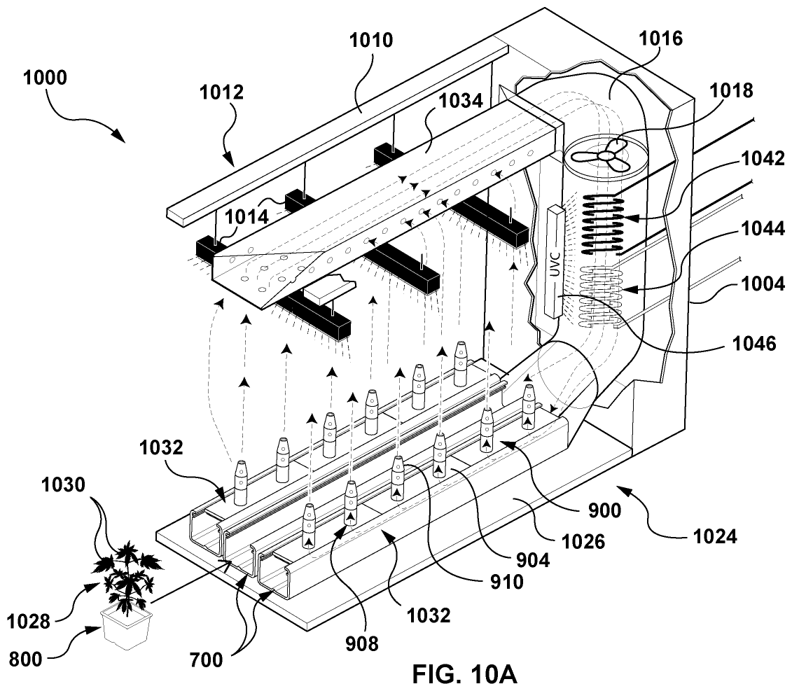

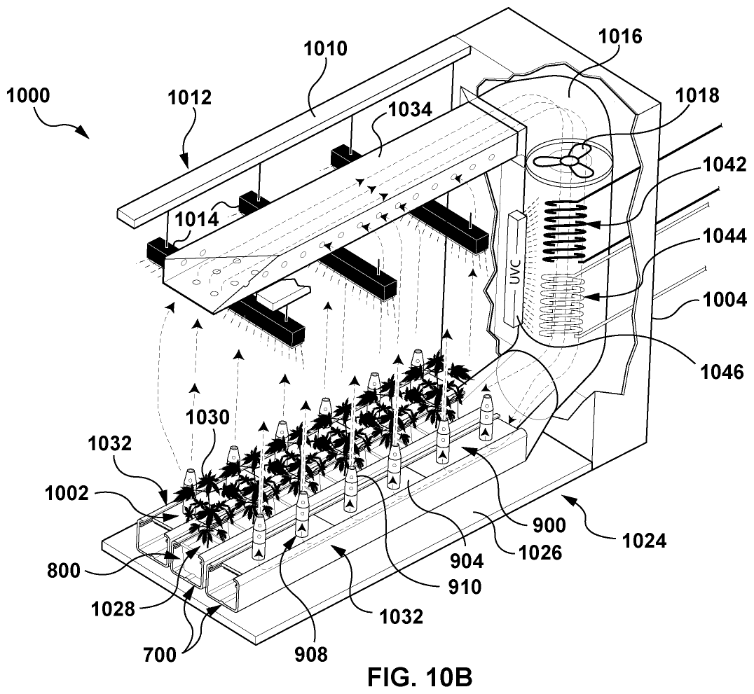

Reference is now made to FIGS. 10A and 10B, which show one illustrative embodiment of a modular recirculating air distribution and heat extraction system, indicated generally by reference 1000.

The modular air distribution and heat extraction system 1000 comprises a support 1024 which includes a cabinet 1004, a longitudinally extending platform 1026 coupled to the cabinet 1004, and a longitudinally extending agricultural lighting system 1012 coupled to the cabinet 1004. The agricultural lighting system 1012 may be of any suitable type; in the illustrated embodiment the agricultural lighting system 1012 comprises a plurality of spaced-apart lighting bars 1014 suspended from fixture arms 1010 extending from the cabinet 1004 substantially parallel to the platform 1026, which also extends from the cabinet 1004. The lighting bars 1014 may be, for example, MetaRail™ or HyperRail™ lighting bars. An air return duct 1034 also extends substantially parallel to the platform 1026, and may be supported directly or indirectly by the fixture arms 1010. For example, the air return duct 1034 may rest atop the lighting bars 1014. Two air supply ducts 1032, each formed from an assembly of the multipurpose cultivation carrier 700, manifold plates 900 and diffuser/reducers 910 as shown in FIG. 9B, are disposed on either side of the platform 1026 along the long edges thereof. While the illustrated embodiment has two air supply ducts 1032 and a single air return duct 1034, other embodiments may have a single air supply duct and/or more than two air supply ducts and/or more than one air return ducts.

A recirculation duct 1016 passes through the cabinet 1004 of the modular air distribution and heat extraction system 1000 and connects the air return duct 1034 in fluid communication with the air supply ducts 1032. A fan 1018 is disposed in cabinet 1004 and configured to draw air from the air return duct 1034 and supply that air to the air supply ducts 1032. Thus, the fan 1018 is configured to apply negative pressure to the air return duct 1034 and to apply positive pressure to the air supply ducts 1032. The fan 1018 is preferably a variable speed fan to support different flow rates depending on the configuration, for example for different lengths of the platform 1026. Although a fan is shown for purposes of illustration, any suitable air circulation mechanism may be used. A cooling coil 1042, reheat coil 1044 and UV sterilizing lighting 1046 are disposed in the recirculation duct 1016, interposed between the air return duct 1034 and the air supply ducts 1032. The cooling coil 1042 cools and dehumidifies air drawn from the air return duct 1034, the reheat coil 1044 can reheat the air to a desired temperature setpoint if too much cooling is applied, and the UV sterilizing lighting 1046 sterilizes any condensate that may accumulate on the cooling coil 1042. Certain features are not shown for simplicity of illustration but are within the capability of one skilled in the art, now informed by the present disclosure. For example, thermostatic control, one or more valves (e.g. three-way valves to control flow through the coils for 1042, 1044 for load control), and drainage for dehumidification may be provided. The cooling coil 1042 and the reheat coil 1044 may be circulating fluid coils coupled to components such as chillers, circulation pumps and compression fluid coolers, which may be integrated into the cabinet 1004 of the modular recirculating air distribution and heat extraction system 1000 or may be external thereto. Thus, the modular recirculating air distribution and heat extraction system 1000 includes an integrated HVAC system comprising the recirculation duct 1016, fan 1018, cooling coil 1042, reheat coil 1044 and optional UV sterilizing lighting 1046, all positioned within the cabinet 1004 of the modular recirculating air distribution and heat extraction system 1000. The HVAC system is, aside from any external connections for electrical power and circulating air conditioning fluids to external components, substantially self-contained.

In one embodiment, a third multipurpose cultivation carrier 700 is disposed between the two air supply ducts 1032 on the platform 1026, and a plurality of plant containers 800 containing plants 1028 can be slidably received therein so that the plants 1028 are carried by the platform 1026, as shown in FIG. 10B. Each of the plants 1028 has a plurality of leaves 1030 forming a plant canopy 1002. The agricultural lighting system 1012 is disposed on the dorsal side of the plant canopy 1002 and is arranged to deliver agricultural light to the dorsal side of the plant canopy 1002.

The air supply ducts 1032 are positioned and configured to apply positive air pressure on the ventral side of the plant canopy 1002 and the air return ducts 1034 are positioned and configured to apply negative air pressure on the dorsal side of the plant canopy 1002. By this arrangement, when the positive air pressure and the negative air pressure are applied, the negative air pressure draws air supplied by the positive air pressure on the ventral side of the plant canopy 1002 across the plant canopy 1002 past the dorsal side of the plant canopy 1002 to withdraw heat and moisture from the plant canopy 1002. The air is then recirculated through the recirculation duct 1016, where it is conditioned by the cooling coil 1042, reheat coil 1044 and optional UV sterilizing lighting 1046, and then returned to the air supply ducts 1032.

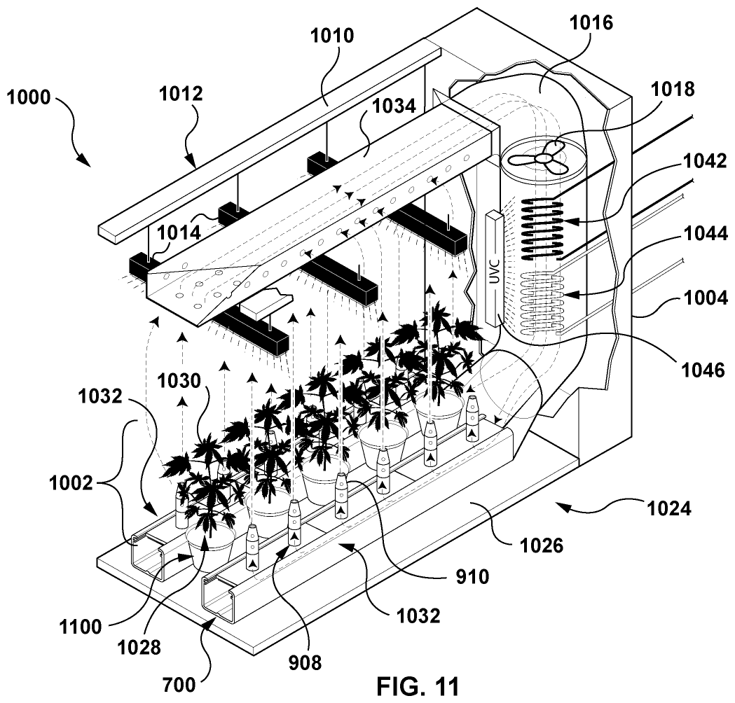

FIG. 11 shows an arrangement of the modular recirculating air distribution and heat extraction system 1000 in which, instead of a third multipurpose cultivation carrier 700, a plurality of individual plant containers 1100 are disposed between the two air supply ducts 1032, directly on the platform 1026. Thus, the modular recirculating air distribution and heat extraction system 1000 is compatible with a wide range of plant containers.

While the illustrated embodiments show a plurality of plants 1028 carried by the platform 1026, in other embodiments there may be only a single plant carried by the support, with the leaves of the single plant forming the plant canopy.

Multiple instances of the modular recirculating air distribution and heat extraction system 1000 can be arranged in tiers, analogously to the arrangement shown in FIG. 3.

As can be seen in FIGS. 10A to 11, the multipurpose cultivation carriers 700, including those that form the air supply ducts 1032 and those that carry the plants 1028, extend substantially parallel to the direction of airflow through the air return duct 1034.

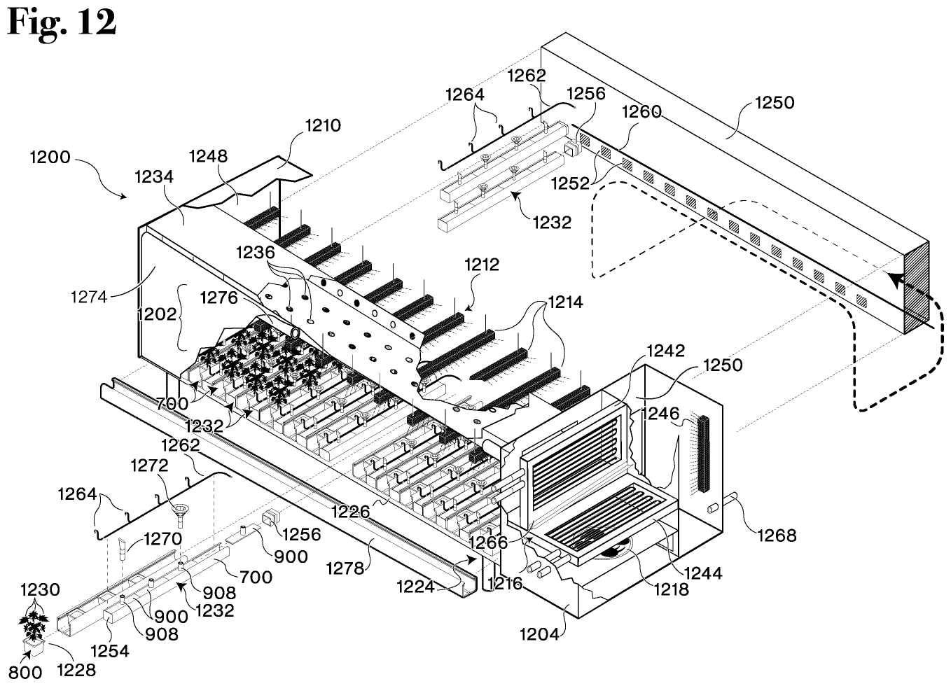

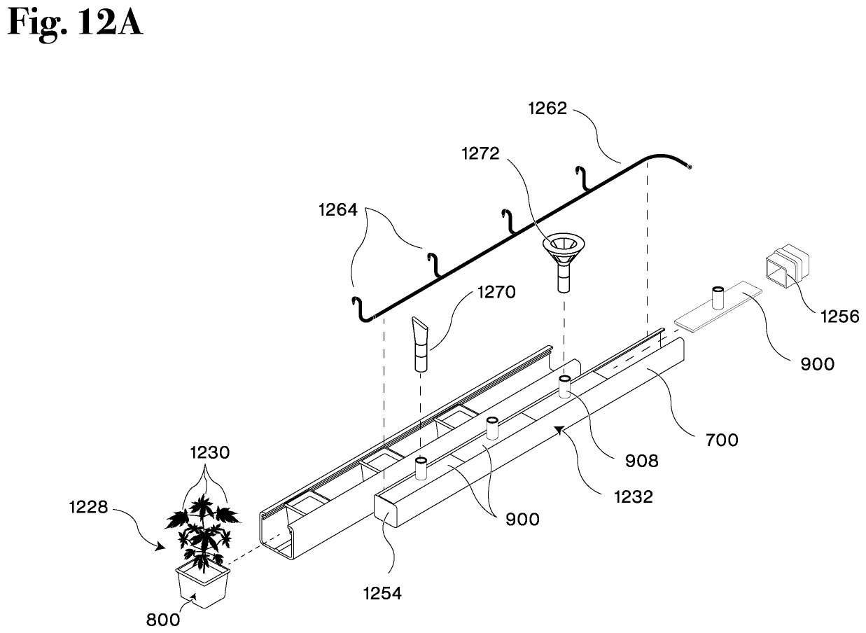

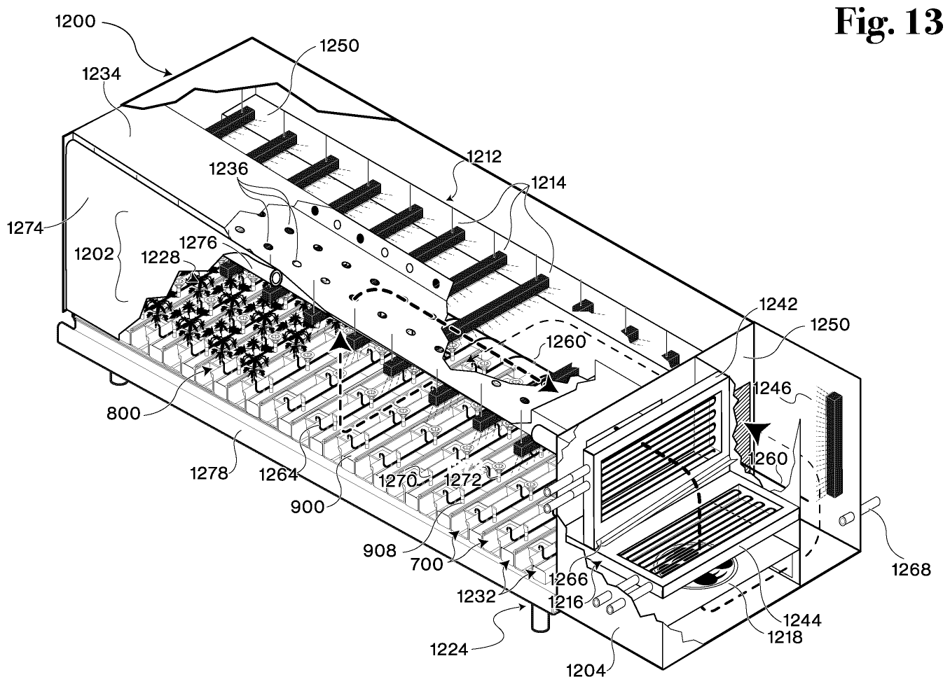

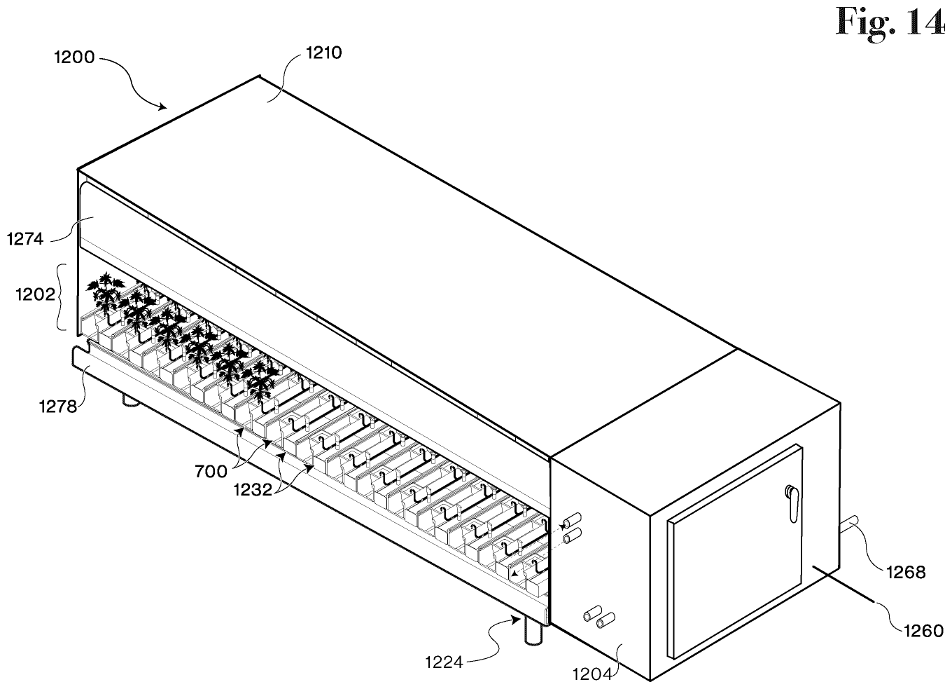

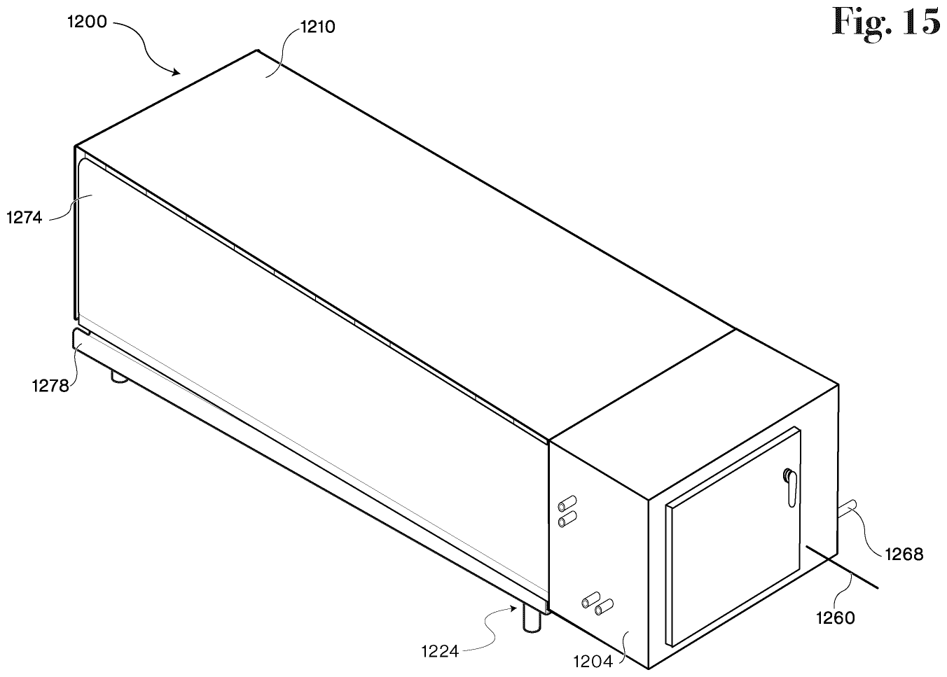

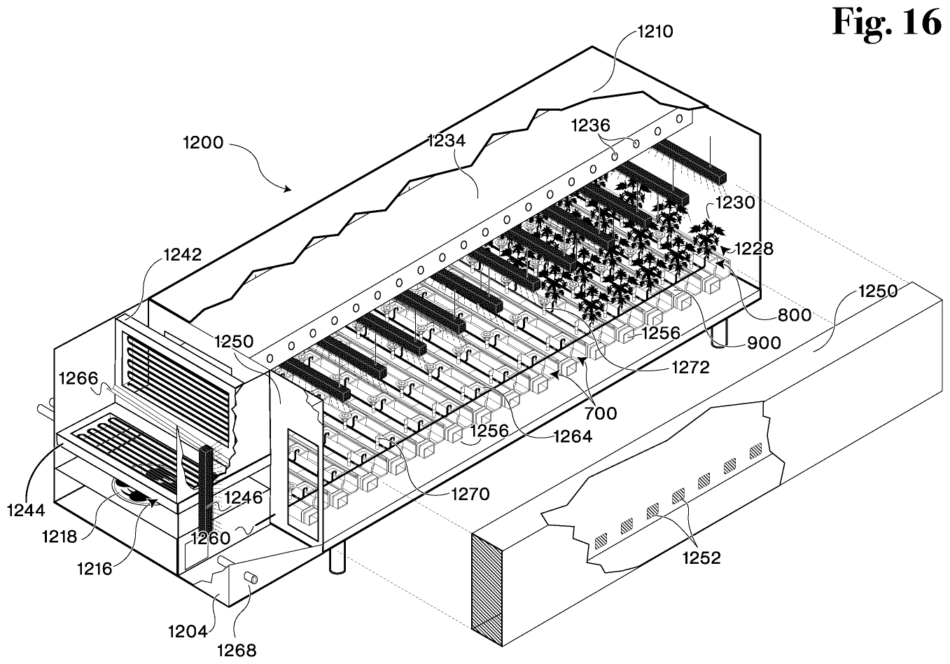

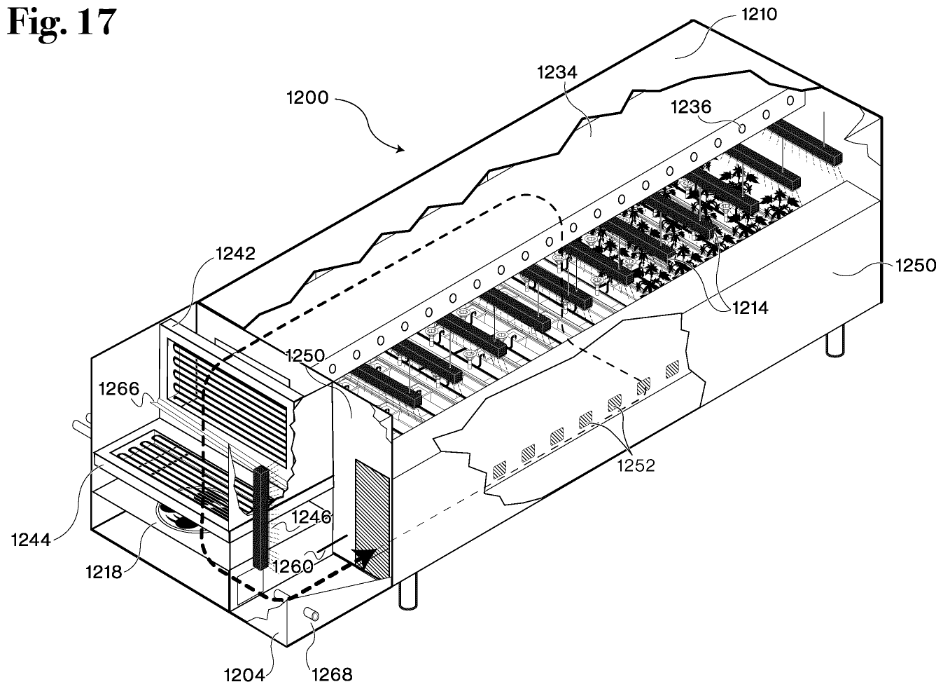

Reference is now made to FIGS. 12 to 17, which show another illustrative embodiment of a modular recirculating air distribution and heat extraction system, indicated generally by reference 1200. The modular recirculating air distribution and heat extraction system 1200 shown in FIGS. 12 to 17 is conceptually similar to the modular air distribution and heat extraction system 1000 shown in FIGS. 10A to 11, and may make use of the same multipurpose cultivation carriers 700, manifold plates 900 and diffuser/reducers 910 shown in FIGS. 7 to 9B, or similar cultivation carriers, manifold plates and diffuser/reducers. Thus, in general, like reference numerals denote corresponding features, except with the prefix “12” instead of “10”. The modular recirculating air distribution and heat extraction system 1200 shown in FIGS. 12 to 17 differs from the modular air distribution and heat extraction system 1000 shown in FIGS. 10A to 11 in that the modular recirculating air distribution and heat extraction system 1200 shown in FIGS. 12 to 17 has the multipurpose cultivation carriers 700 and the air supply ducts 1232 extending substantially transverse to the direction of airflow through the air return duct 1034.

The modular air distribution and heat extraction system 1200 comprises a support 1224. In this embodiment, the support 1224 comprises a cabinet 1204 housing various components described further below, a longitudinally extending platform 1226 coupled to the cabinet 1204, and a longitudinally extending roof 1210 opposite the and substantially parallel to the platform 1226 and also coupled to the cabinet 1204. The roof 1210 is optional; in alternate embodiments the roof may be omitted and the air return duct(s) 1034 may function as a roof as well. A longitudinally extending agricultural lighting system 1212, which may be of any suitable type, is also provided. In the illustrated embodiment the agricultural lighting system 1212 comprises a plurality of spaced-apart lighting bars 1214, such as for example MetaRail™ or HyperRail™ lighting bars, suspended from the roof 1210.

A hollow supply plenum 1250 is in fluid communication with the interior of the cabinet 1204 at one end of the supply plenum 1250; the supply plenum 1250 is closed at the other end. The supply plenum 1250 extends from the cabinet 1204 substantially perpendicular to and substantially coterminous with the roof 1210 and platform 1226, where it meets an end plate 1248 opposite the cabinet 1204 and is also joined to the platform 1226 and the roof 1210. The supply plenum has a series of spaced apart supply plenum outlet apertures 1252 which feed air to a corresponding series of air supply ducts 1232. The air supply ducts 1232 may be formed using multipurpose cultivation carriers 700 and manifold plates 900 as described above and shown in FIGS. 9A and 9B, with a sealing member or end plate 1254 at the distal end and a hollow duct coupler 1256 at the proximal end to connect each of the air supply ducts 1232 in fluid communication with the supply plenum 1250. The air supply ducts 1232 rest on the platform 1226. An air return duct 1234 having a plurality of inlet apertures 1236 also extends substantially parallel to the platform 1226, and may be supported directly or indirectly by the roof 1210 (where a roof is present) or by other structural elements. Thus, in the illustrated embodiment, the air return duct 1234 is separate from and unsupported by the agricultural lighting system 1212. While the illustrated embodiment shows a single air return duct 1234, other embodiments may have more than one air return duct.

Because the supply plenum outlet apertures 1252 are spaced apart, the air supply ducts 1232 are also spaced apart along the length of the platform 1226. Multipurpose cultivation carriers 700, each having plurality of plant containers 800 containing plants 1228 slidably or otherwise received therein, can fit between adjacent ones of the air supply ducts 1232 on the platform 1226 so that the plants 1228 are carried by the platform 1226. Each of the plants 1228 has a plurality of leaves 1230 forming a plant canopy 1202. The agricultural lighting system 1212 is disposed on the dorsal side of the plant canopy 1202 and is arranged to deliver agricultural light to the dorsal side of the plant canopy 1202. The multipurpose cultivation carriers 700 used to form the air supply ducts 1232 may be of the same size as the multipurpose cultivation carriers 700 used to house the containers 800 and plants 1228, or may be of a different size. For example, the multipurpose cultivation carriers 700 used to form the air supply ducts 1232 may be smaller than the multipurpose cultivation carriers 700 used to house the containers 800 and plants 1228, as shown in FIG. 12A, to provide relatively more space for the containers 800 and plants 1228. Also, by providing relatively taller air supply ducts and relatively shorter cultivation carriers for plants in a juvenile (and hence more fragile) state of development, the juvenile plants can be placed below the airflow so that little or no air blows onto the juvenile plants. This reduces the need for transplanting/moving plants from one growing environment to another as they mature.

A main fertigation line 1260 extends along the supply plenum 1250 above the supply plenum outlet apertures 1252, and connects in fluid communication with branch fertigation lines 1262 having drippers 1264 to supply water and nutrients to the plants 1228.

The air distribution and heat extraction system 1200 is a modular recirculating air distribution and heat extraction system. The cabinet 1204 forms a recirculation duct 1216 that connects the air return duct 1234 in fluid communication with the supply plenum 1250 and thereby with the air supply ducts 1232. A fan 1218, preferably a variable speed fan, is disposed in the cabinet 1204 and configured to draw air from the air return duct 1234 and supply that air to the air supply ducts 1232. The fan 1218 is thus configured to apply negative pressure to the air return duct 1234 on the dorsal side of the plant canopy 1202 and to apply positive pressure to the air supply ducts 1232 on the ventral side of the plant canopy 1202. While a fan is shown for purposes of illustration, any suitable air circulation mechanism may be used. A cooling coil 1242, reheat coil 1244 and UV sterilizing lighting 1246 are disposed in the recirculation duct 1216 formed by the cabinet 1204. Thus, the cooling coil 1242, reheat coil 1244 and UV sterilizing lighting 1246 are interposed between the air return duct 1234 and the air supply ducts 1232. The cooling coil 1242 cools and dehumidifies air drawn from the air return duct 1234, the reheat coil 1244 can reheat the air to a desired temperature setpoint if too much cooling is applied, and the UV sterilizing lighting 1246 sterilizes the cooling coil 1242 and any film that may form thereon from the condensate. As a result, the air supply ducts 1232 are coupled (via duct couplers 1256 and supply plenum 1250 in fluid communication with a source of actively cooled forced air (cabinet 1204). A drip tray 1266 is provided for drainage of condensate dripping from the cooling coil 1242. The cooling coil 1242 and the reheat coil 1244 may be circulating fluid coils coupled to components such as chillers, circulation pumps and compression fluid coolers, some or all of which may be integrated into the cabinet 1204 of the modular recirculating air distribution and heat extraction system 1200 or may be external thereto. Thus, the modular recirculating air distribution and heat extraction system 1200 includes an integrated HVAC system comprising the recirculation duct 1216 formed by the cabinet 1204, fan 1218, cooling coil 1242, reheat coil 1244 and optional UV sterilizing lighting 1246, as well as optional modulating and bypass valves, all positioned within the cabinet 1204 of the modular recirculating air distribution and heat extraction system 1200. The HVAC system is, aside from any external connections for electrical power and circulating air conditioning fluids to external components, substantially self-contained. A retractable light containment curtain 1274 wound on a spool 1276 supported by the roof 1210 can cover the open side opposite the supply duct 1250 to limit UV exposure to personnel and then be retracted to access the plants 1228. Additionally, a CO₂ inlet 1268 into the recirculation duct 1216 formed by the cabinet 1204 (or into the supply plenum 1250) may be provided to enrich the recirculating air with CO₂ to enhance plant growth. As with other embodiments, certain features within the capability of one skilled in the art, now informed by the present disclosure, are not shown for simplicity of illustration but may be present in various implementations. These include thermostatic, CO₂ or other sensors for environmental control, modulating valves, bypass valves or other valves (e.g. three-way valves for load control), among others.

In the illustrated embodiment shown in FIGS. 12 to 17, the nipples 908 on the manifold plates 900 can be fitted with different types of diffuser/reducers or nozzles depending on the location and desired airflow and distribution goals. In the illustrated embodiment, the plants 1228 are enclosed on five sides by the end plate 1248, the supply plenum 1250, the cabinet 1204, the roof 1210 and the platform 1226, with the side opposite the supply plenum 1250 being open to provide access. The most distal nipples 908 (the nipples 908 furthest from the supply plenum 1250) on each of the air supply ducts 1232 may be fitted with an air curtain nozzle 1270. The air curtain nozzles 1270 cooperate to form an air curtain on the side opposite the supply plenum 1250, thereby effectively enclosing the plants 1228. In some embodiments, the end plate may be omitted and specialized nozzles may provide an air curtain at the end of the platform 1226 opposite the cabinet 1204. The interior nipples 908 (the nipples 908 between the most distal nipples 908 and the supply plenum 1250) may be fitted with canopy airflow nozzles 1272 adapted to blow air through the plant canopy 1202. Because the airflow through each of the air supply ducts 1232 will vary depending on its longitudinal position along the supply plenum 1250 (as more air is bled off), the air curtain nozzles 1270 and the canopy airflow nozzles 1272 are preferably configured to be individually adjustable so as to enable maintenance of a relatively consistent airflow for the air curtain and through the plant canopy 1202. For example, nozzles may be adjustable, or may have ports that can be selectively sealed or opened, such as by plugs. Alternatively, the nozzles may have a fixed configuration, with each configuration being designated for a specific position. Alternatively or additionally, baffle plates or other airflow control elements may be disposed within the supply plenum 1250 and/or the air supply ducts 1232. Configuration of the nozzles will of course depend on the spacing and configuration of the end plate 1248, the supply plenum 1250, the cabinet 1204, the roof 1210 and the platform 1226, as well as the desired airflow and distribution goals and is within the capability of one of ordinary skill in the art, now informed by the present disclosure. For example, computational fluid dynamic (CFD) modeling may be used. Additionally, as noted above the fan 1218 is preferably a variable speed fan which may further facilitate flow control.

In operation, when the fan 1218 is active, air is forced into the supply plenum 1250, then through the supply plenum outlet apertures 1252 into the air supply ducts 1232, which apply positive pressure to the ventral side of the plant canopy 1202. At the same time, the fan also draws air from the air return duct 1234 past the cooling coil 1242, reheat coil 1244 and UV sterilizing lighting 1246, to thereby apply negative pressure to the air return duct 1234 on the dorsal side of the plant canopy 1002. When the positive air pressure and the negative air pressure are applied, the negative air pressure draws air supplied by the positive air pressure on the ventral side of the plant canopy 1202 across the plant canopy 1202, past the dorsal side of the plant canopy 1202, to withdraw heat (e.g. from the agricultural lighting system 1214) and humidity (substantially from plant respiration) from the plant canopy 1202. The dashed lines in FIGS. 12, 13 and 17 show an illustrative airflow. The use of the air curtain nozzles 1270 to form an air curtain on the side opposite the supply plenum 1250 creates an enclosed microclimate; the light containment curtain 1274 merely limits UV light exposure from the agricultural lighting system 1212 and is not required to maintain the microclimate. A drip tray or gutter 1278 may be disposed along the platform 1276 opposite the spool 1276 for the light containment curtain 1274.

Multiple instances of the modular recirculating air distribution and heat extraction system 1200 can be arranged in stacks or tiers, analogously to the arrangement shown in FIG. 3. Thus, the support 1224 may in some embodiments comprise a plurality of tiered plant canopies, with a plurality of tiered air return ducts disposed on dorsal sides of respective ones of the plant canopies and a plurality of air supply ducts disposed on ventral sides of respective ones of the plant canopies. In such embodiments, a roof of a lower tier may also function as a platform of an adjacent upper tier. Each tier will preferably have its own independent cabinet and HVAC system.

As noted above, the modular recirculating air distribution and heat extraction system 1200 shown in Figure has the multipurpose cultivation carriers 700 and the air supply ducts 1232 extending substantially transverse to the direction of airflow through the air return duct 1034. This transverse arrangement may facilitate maintenance and harvesting of the plants while still enabling a large number of plants to be serviced by a single HVAC system. A technician can, once the light containment curtain 1274 is retracted, move along the length of the platform 1226, slide a multipurpose cultivation carrier 700 out, perform whatever steps are required, slide the multipurpose cultivation carrier 700 back into position, and then index over to the next multipurpose cultivation carrier 700.

The ability to connect a series of ducts end-to-end, to provide ducts of various sizes, and to provide single or multiple tiers, allows for scalability and adaptability of the system depending on the particular application. The positioning, spacing and size of the manifolds, as well as the airflow rate and cooling configuration, will be dependent on the design, layout and requirements of the facility in which the plants are grown, as well as the type of plant(s).

It is also contemplated that the presently described systems and methods can be employed in aquaponics applications as well.

While illustrative embodiments have shown a vertical arrangement in which the airflow from the ventral side of the plant canopy toward the dorsal side of the plant canopy is substantially vertical relative to the earth, the present disclosure is not so limited, and also contemplates, for example, arrangements in which the airflow from the ventral side of the plant canopy toward the dorsal side of the plant canopy is substantially horizontal relative to the earth. For example, it is contemplated that the principles applied herein may be applied to produce substantially horizontal airflow from the ventral side of the plant canopy toward the dorsal side of the plant canopy in a system such as the AirBox™ Horticultural Production Platform offered by the aforesaid AgricUltra Advancements Inc. and described in PCT International Patent Application No. PCT/CA2019/050322 filed on Mar. 15, 2019, the teachings of which are hereby incorporated by reference.

Certain illustrative embodiments have been described by way of example. It will be apparent to persons skilled in the art that a number of variations and modifications can be made without departing from the scope of the claims.

What is claimed is:

1. A method for air distribution and heat extraction for a plant canopy, the method comprising:
applying positive air pressure on a ventral side of the plant canopy; and
applying negative air pressure on a dorsal side of the plant canopy;
whereby the negative air pressure draws air supplied by the positive air pressure on the ventral side of the plant canopy across the plant canopy past the dorsal side of the plant canopy to withdraw heat from the plant canopy.

2. The method of claim 1, wherein the heat is from an agricultural lighting system.

3. The method of claim 1, wherein the negative air pressure draws air supplied by the positive air pressure on the ventral side of the plant canopy across the plant canopy past the dorsal side of the plant canopy to withdraw humidity from the plant canopy.

4. The method of claim 3, wherein the humidity is substantially from plant respiration.

5. The method of claim 1, wherein the positive air pressure results from forced air from an HVAC system.

6. The method of claim 3, wherein the forced air is actively cooled before reaching the ventral side of the plant canopy.

7. The method of claim 6, wherein the forced air is reheated to a desired temperature setpoint after cooling if too much cooling is applied.

8. The method of claim 5, wherein the forced air is cleaned before reaching the ventral side of the plant canopy.

9. The method of claim 5, wherein the forced air is ambient air.

10. The method of claim 1, wherein the negative air pressure results from suction into a bulk return inlet of an HVAC system.

11. An air distribution and heat extraction system for plant cultivation, comprising:
a support;
at least one plant carried by the support, the at least one plant having a plurality of leaves forming at least one plant canopy;
at least one air supply duct positioned and configured to apply positive air pressure on a ventral side of the at least one plant canopy;
at least one air return duct positioned and configured to apply negative air pressure on a dorsal side of the at least one plant canopy;
whereby, when the positive air pressure and the negative air pressure are applied, the negative air pressure draws air supplied by the positive air pressure on the ventral side of the at least one plant canopy across the at least one plant canopy past the dorsal side of the at least one plant canopy to withdraw heat from the at least one plant canopy.

12. The air distribution and heat extraction system of claim 11, wherein when the positive air pressure and the negative air pressure are applied, the negative air pressure draws air supplied by the positive air pressure on the ventral side of the at least one plant canopy across the at least one plant canopy past the dorsal side of the at least one plant canopy to withdraw humidity from the at least one plant canopy.

13. The air distribution and heat extraction system of claim 12, wherein the humidity is substantially from plant respiration.

14. The air distribution and heat extraction system of claim 11, wherein the at least one air supply duct is coupled in fluid communication with a source of actively cooled forced air.

15. The air distribution and heat extraction system of claim 14, wherein the at least one air return duct vents to ambient.

16. The air distribution and heat extraction system of claim 11, wherein the support is a building floor and the at least one air supply duct is embedded in the building floor.

17. The air distribution and heat extraction system of claim 11, wherein:
the at least one air supply duct is coupled in fluid communication with an HVAC system and configured to receive treated forced air from the HVAC system; and
the at least one air return duct is coupled in fluid communication with the HVAC system and configured to deliver the air drawn from the plant canopy to a bulk return intake of the HVAC system.

18. The air distribution and heat extraction system of claim 11, wherein:
the air distribution and heat extraction system is a modular recirculating air distribution and heat extraction system; and
the HVAC system is an integrated HVAC system comprising a recirculation duct, an air circulation mechanism, a cooling coil and a reheat coil, all positioned within a cabinet of the modular recirculating air distribution and heat extraction system.

19. The air distribution and heat extraction system of claim 11, further comprising an agricultural lighting system disposed on a dorsal side of the plant canopy and configured to deliver agricultural light to the plant canopy.

20. The air distribution and heat extraction system of claim 13, wherein the at least one air return duct is carried by the agricultural lighting system.

21. The air distribution and heat extraction system of claim 13, wherein the at least one air return duct is separate from and unsupported by the agricultural lighting system.

22. The air distribution and heat extraction system of claim 11, wherein:
the support is a tiered support;
the at least one plant comprises a plurality of plants arranged on tiers of the tiered support whereby the at least one plant canopy comprises a plurality of tiered plant canopies; and
the at least one air return duct comprises a plurality of air return ducts disposed on dorsal sides of respective ones of the plant canopies.

23. The air distribution and heat extraction system of claim 22, wherein the at least one air supply duct comprises a plurality of air supply ducts disposed on ventral sides of respective ones of the plant canopies.

24. Anything substantially as herein shown or described.
